(19) United States
(12) Patent Application Publication
(10) Pub. No.: US 2006/0007965 A1
(43) Pub. Date: Jan. 12, 2006

(54) Passive Q-switch modulated fiber laser

(76) Inventors: Nikolai Tankovich, San Diego, CA (US); Alexei Lukashev, San Diego, CA (US); Alexander Kirhanov, Leon (MX); Valery Filippov, Leon (MX); Andrei Staroovmov, Leon (MX)

Correspondence Address: JOHN R. ROSS, PO BOX 2138, DEL MAR, CA, 92014, US

(21) Appl. No.: 10/890,076

(22) Filed: Jul. 12, 2004

(51) Int. Cl. H01S 3/11; H01S 3/30

(52) U.S. Cl. 372/10; 372/6

(57) ABSTRACT

An all-fiber erbium laser oscillating in a passive Q switched mode. The laser includes a crystal saturable absorber that may be Co²⁺:ZnSe or Cr²⁺:ZnSe. In preferred embodiments continuous pumping or short pulse pumping may be utilized. The laser is characterized by low threshold high-power, short-pulse generation. In preferred embodiments the threshold is only about 20 mW. The crystals are bleached at extremely low intensity, of about 0.8 kW/cm² and provide moderate relaxation time of the excited state (290 μs) within a spectral range of about 1400-1800 nm. The simplicity of the design and low cost of that laser 2000).

This invention relates to fiber lasers and in particular to passive Q-switch fiber lasers for medical applications.

### BACKGROUND OF THE INVENTION

Q-switched lasers are well known. In these lasers the laser pumping process is allowed to build up to a much larger than usual population inversion inside the laser cavity while the cavity itself is kept from oscillating by removing the cavity feedback or greatly increasing the cavity losses—usually by blocking or removing one of the end mirrors. Then, after a large inversion has developed, the cavity feedback is restored; i.e., the “cavity Q” is switched back to its usual large value using some suitably rapid modulation method. The result in general is very short, intense burst of laser output that dumps all the accumulated population inversion in a single short laser pulse, typically only a few tens of nanoseconds long. The modulation method may be active and passive. Active modulation Q-switching in fiber lasers is currently well-known, wide spread and well investigated. Techniques for active Q switching involve rotating mirrors, electro-optic and acousto-optic. Passive Q switching usually involves the use of a saturable absorber. Thin films, that burn away, can also be used as a satruable absorber.

Fiber lasers are lasers made using optical fibers. Light emitting atoms are doped into the core of an optical fiber that confines the light the atoms emit. Optical fibers with mirrors on each end can serve as oscillators. Optical fiber amplifiers are widely used and are similar to the fiber lasers but in the amplifiers there is on oscillation.

Techniques for Q-switching optical fibers are known. Some active Q-switching techniques are described in the following papers:
1. A. Chandonet and G. Larose, “High-power Q-switched erbium fiber laser using an all-fiber intensity modulator”, Opt. Eng., 32, 2031-2035 (1993).
2. O. G. Okhotnikov and J. R. Salsedo. “Dispersively Q-switched Er fibre laser with intracavity 1.48 μm laser diode as pumping source and nonlinear modulator”, Electron. Lett., 30, 702-704 (1994).
3. J. M. Sousa and O. G. Okhotnikov. “Multiple wavelength Q-switched fiber laser”, IEEE Photon. Techn. Lett., 11, 1117-1119 (1999).
4. G. P. Lees, D. Taverner, D. J. Richardson, and L. Dong. “Q-switched erbium doped fibre laser utilising a novel large mode area fibre>>, Electron. Lett., 33, 393-394 (1997).
5. P. Roy, D. Pagnoux, L. Mouneu, and T. Midavaine. “High efficiency 1.53 μm all-fibre pulsed source based on a Q-switched erbium doped fibre ring laser”. Electron. Lett., 33, 1317-1318 (1997).
6. Z. J. Chen, A. B. Grudinin, J. Porta, and J. D. Minelly. “Enhanced Q switching in double-clad fiber lasers”. Opt. Lett., 23, 454-456 (1998).
7. S. V. Chernikov, Y. Zhu, J. R. Tailor, and V. P. Gapontsev. “Supercontnuum self-Q-switched ytterbium fiber laser”, Opt. Lett., 22, 298-300 (1997).

The following papers describe some prior art passive Q-switching techniques:
1. R. Paschotta, R. Haring, E. Gini, H. Melchior, U. Keller, H. L. Offerhaus, and D. J. Richardson. “Passively Q-switched 0.1-mJ fiber laser system at 1.53 μm”, Opt. Lett. 24, 388-400 (1999).
2. T.-Y. Tsai and M. Birnbaum, “Co²⁺:ZnS and Co²⁺:ZnSe saturable absorber Q switches”, J. Appl. Phys., 87, 25-29 (2000).
3. A. V. Podlipensky, V. G. Shcherbitsky, N. V. Kuleshov, V. P. Mikhailov, V. I Levchenko, and V. N. Yakimovich. “Cr²⁺:ZnSe and Co²⁺:ZnSe saturable-absorber Q switches for 1.54 μm Er:glass lasers”, Opt. Lett., 24, 960-962 (1999).

It has been shown that a passive Q switched ytterbium laser generates rather high-power (up to 10 kW) with short giant pulses, but needs high pump power of about 2.5 W. A prior art erbium laser developed using the same principle is very unstable. Use of Q switched lasers for medical purposes is well known. Their very short pulses can vaporize tissue and other materials. They are used in medicine and for surgery, tattoo removal, skin peeling and hair removal. Medical lasers can be large and expensive.

What is needed is an inexpensive all-fiber laser emitting high average and peak power pulses. Such lasers are especially needed for medical applications where the laser beam is needed at internal sites.

### SUMMARY OF THE INVENTION

The present invention provides an all-fiber erbium laser oscillating in a passive Q switched mode. The laser includes a crystal saturable absorber that preferably is a crystal of Co²⁺:ZnSe or Cr²⁺:ZnSe. In preferred embodiments continuous pumping or short pulse pumping may be utilized. The laser is characterized by low threshold high-power, short-pulse generation. In preferred embodiments the threshold for Q-switching is only about 20 mW. The crystals are bleached at extremely low intensity, of about 0.8 kW/cm² and provide moderate excited state relaxation times of about 290 μs. Lasers of preferred embodiments operate within a spectral range of about 1400-1800 nm. The simplicity of the design and low cost of the laser and the fact that the beam can be transmitted in very thin optical fibers make it very valuable for wide medical application.

### BIREF DESCRIPTION OF THE DRAWINGS

FIG. 1 is a drawing of a laser system.

FIGS. 2A(1) through 2C(2) are examples of intra-cavity intensity vs time.

FIGS. 3A and 3B are graphs showing average power and repetition rate versus pump rate.

FIGS. 4A, 4B and 4C show pulse width, pulse energy, and peak power versus pump rate.

FIGS. 5A and 5B show reflection spectra of the FBG mirrors.

FIGS. 6A and 6B(1) and 6B(2) show experimental snapshots of pulse trains.

FIG. 7 shows experimental dependencies of average power and repetition rate vs pump power.

FIGS. 8A and 8B shows experimental snapshots of pulse trains.

FIG. 9 shows the generation of laser spectra.

FIGS. 10A, 10B and 10C show experimental dependencies of pulse parameters of pulse width, pulse energy, and peak power vs pump power.

FIG. 11 shows an optical setup of a MOPA configuration of the all-fiber laser.

FIG. 12 shows a cold fiber tip for subsurface eye tissues modification

FIG. 13 shows a fiber patched tip for skin epidermis and dermis modification.

FIG. 14 shows a cold fiber tip for fiber laser hair removal.

FIG. 15 shows a cold fiber tip for striae and keloid scar shrinkage.

FIGS. 16A and 16B show features if fiber needle procedure for scull skin perforation for hair transplantation.

FIG. 17 shows fiber tip for myocardium re-vascularization.

FIG. 18 shows fiber tip for soft and hard dental use.

FIGS. 19A through 19H shows features of TURP and OB/GYN procedures.

FIGS. 20A and 20B show features for atherectomy and re-canalization.

### DETAILED DESCRIPTION OF PREFERRED EMBODIMENTS

### First Preferred Embodiment

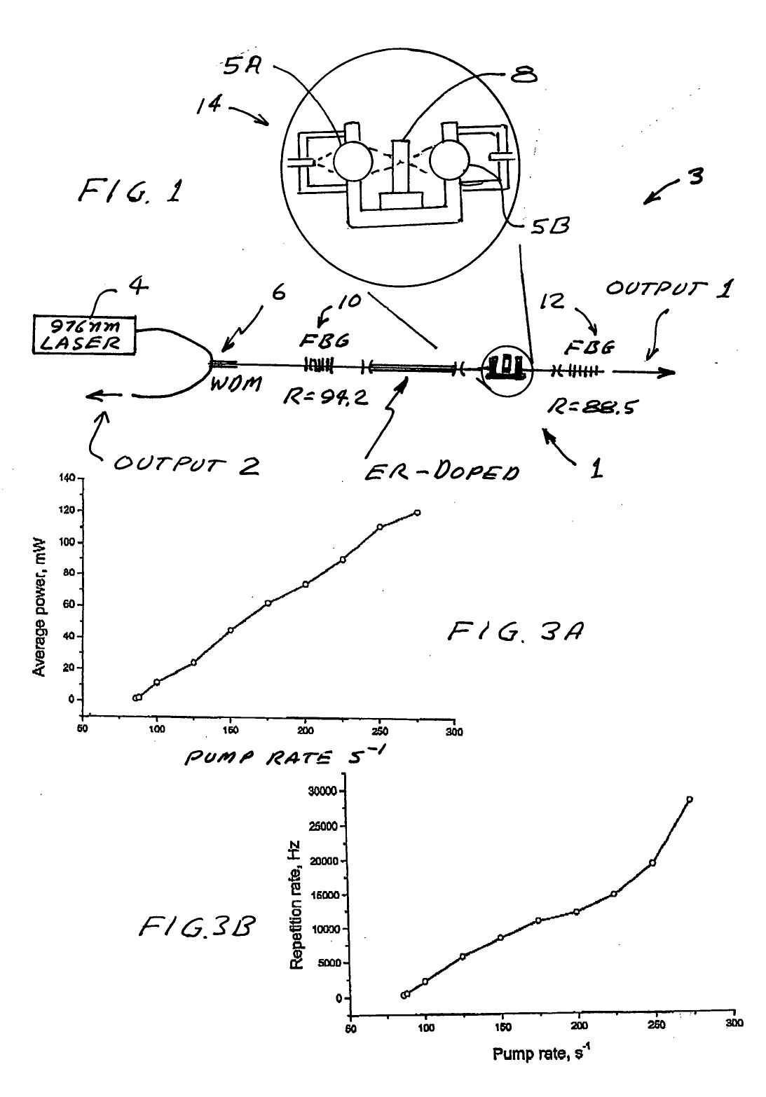

FIG. 1 is an optical schematic of a preferred embodiment 3 of the present invention. A laser cavity 1 is created with single mode erbium doped optical fiber 2 with a core diameter of 6.0 μm and a fiber length of anywhere between 0.2 m and 20 m. Applicant's preferred length is about 1 meter. The doping concentration of erbium ions is sufficient to produce about 1 dB/m to 350 dB/m absorption of the pump wavelength. Radiation from a pump diode laser 4 at a wavelength of 976 nm is launched with a wave divider multiplexer (WDM) coupler 6 into the master cavity. A Co²⁺:ZnSe crystal 8 with initial transmittance Tᵢₙ=70-98% and a thickness 0.3 mm-1 mm is positioned within the cavity and the cavity is defined by two fiber Bragg grating mirrors 10 and 12 with maximum reflection of 94.2% (100-95%) and 88.5% (70-98%), respectively, both gratings are designed for a wavelength of 1560 nm. The laser includes a U-bench unit 14 with a Co²⁺:ZnSe crystal inside as shown in FIG. 1.

U-bench 14 is a holder having a “U” shape as shown at 14 in FIG. 1, which is placed in between two ends of fiber tips and holds those fiber ends. The fiber ends are polished at a small angle of about 9 degrees to the optical axis to exclude back reflection. A small ball type lens 5A with a focal length of about 2 mm is placed at about a double focus distance from the fiber tip as shown in FIG. 1A. The lens relays the image of the fiber tip to the center of U-bench. Then the image of the first fiber tip is relayed back onto the tip of the fiber positioned on the opposite side of U-bench 14 by a second ball type lens 5B. The beam waist is about 15 μm. All surfaces of optical elements including the Co²⁺:ZnSe crystal are coated to decrease reflection in the range of 1400-1800 nm. The system is aligned during fabrication. The inserted loss by introduction of a U-bench in to the fiber could be as low as 0.1 dB. In this preferred embodiment, the power density is adjusted so that the intra-cavity radiation level at the center of U-bench (i.e., the center of the Co²⁺:ZnSe) is about 1 kW/cm². Other parameters of Co²⁺:ZnSe crystal are:

1) absorption cross-section σₛ=5.3×10⁻¹⁹ cm²;

2) upper level lifetime τₛ=0.29×10⁻³ s;

3) bleaching power for Co²⁺:ZnSe, as low as 0.8 kW/cm².

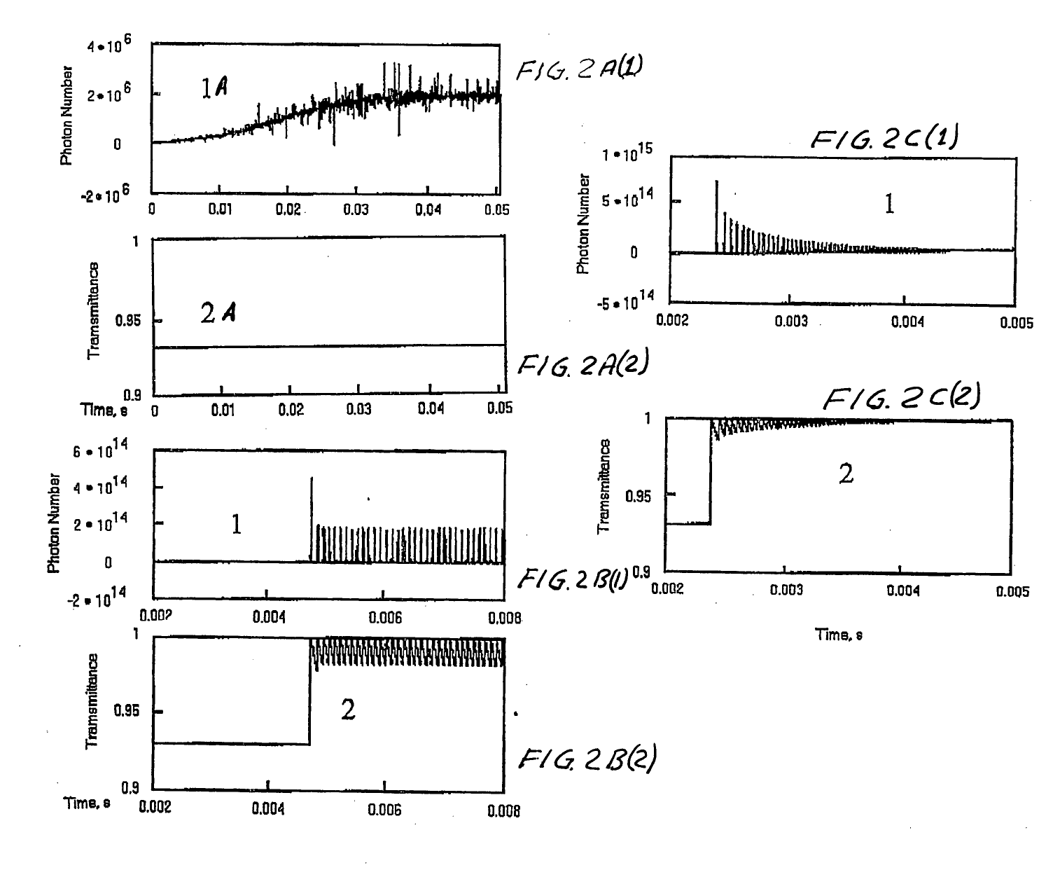

The results of the numerical modeling of this erbium fiber laser with its passive Co²⁺:ZnSe Q-switch are given in FIGS. 2A(1)-4C. FIGS. 2 A,B and C show the dynamics of the laser depending on the pump rate. It is seen that quite different regimes of oscillations could be recognized:

FIGS. 2A(1) and (2) show photon number and transmittance at power levels below the threshold (the area where the laser emits continuous amplified spontaneous radiation);

FIGS. 2B(1) and (2) show what happens when the crystal bleaches to produce a continuous train of periodic giant pulses, and

FIGS. 2C(1) and (2) show how the results of operating substantially above the threshold of transition of the laser where the operating mode changes from the passive Q switch mode to a steady-state CW mode.

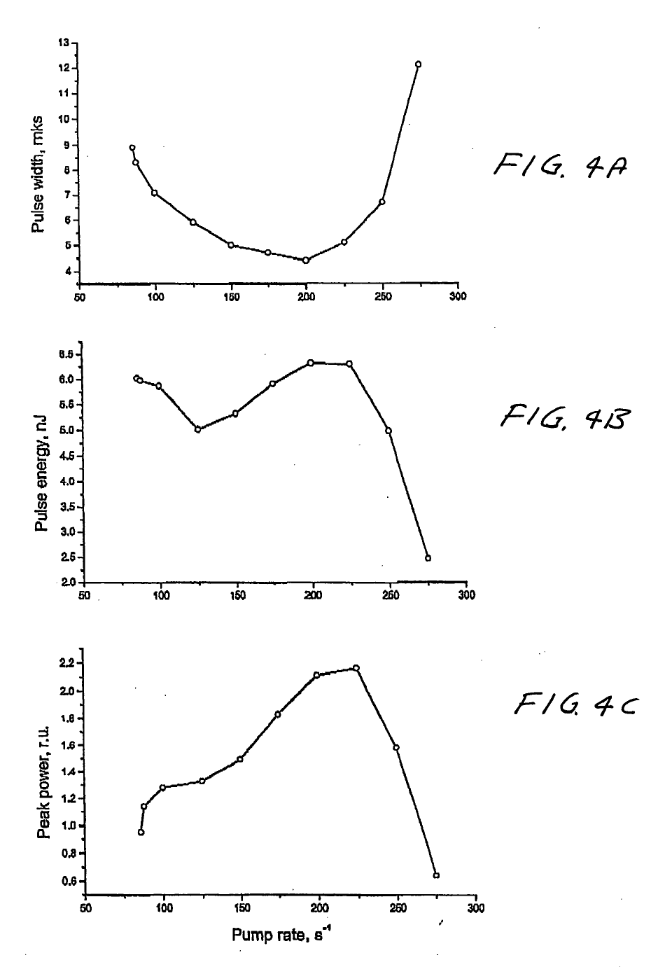

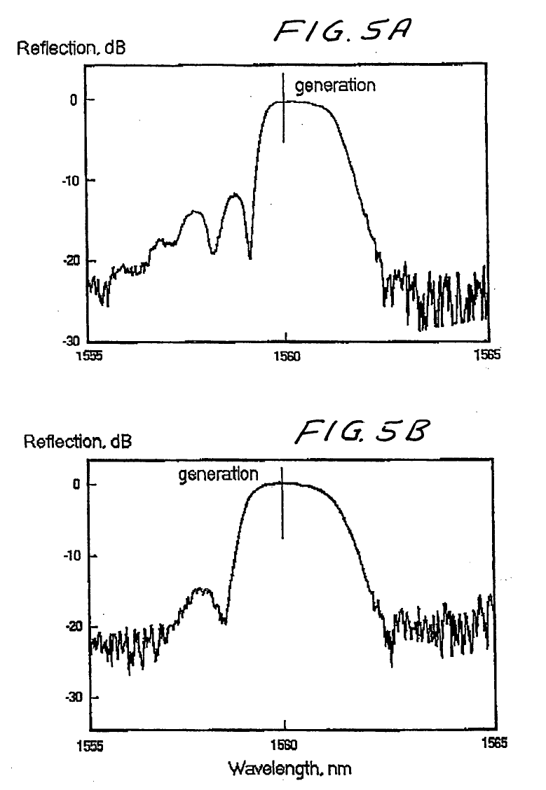

Physically, one can connect the changes in the regime of oscillation with a degree of bleaching of the Co²⁺:ZnSe crystal. FIG. 2A(1) corresponds to the case when stimulated emission power stored in the cavity is insufficient to bleach the Co²⁺:ZnSe crystal. When the Co²⁺:ZnSe crystal is partially bleached the stable periodic pulses at greatly increased pulse power are produced as shown in FIGS. 2B(1) and 2B(2). (Note the change in photon number scale from 10⁶ to 10¹⁴.) When the rising intra-cavity power, after finite round-trips, is able to saturate the Co²⁺:ZnSe SA up to the level of maximum transmittance, the mode changes again as shown in FIGS. 3C(1) and (2). FIGS. 3A and B give the dependences of the basic parameters of the laser operation—average intensity and giant pulse repetition rate as a function of pump repetition rate. FIGS. 4A and B show the pulse duration, energy and peak power as a function of pulse rate. The dependences of pulse energy (and, consequently, average power) of the laser can be estimated using the following formula for output energy of the laser operating in the passive Q switch mode:

$${E}_{out} = - \frac{{hvS}_{a}}{4 {σ}_{a} γ} ln \frac{1}{{R}_{1}} ln \frac{{n}_{a}^{min}}{{n}_{a}^{max}} , \qquad ( 6 )$$

where Eₒᵤₜ is addressed to one of the laser outputs closed by the mirror M₁; nₐ^{min} and nₐ^{max} are the extremum inversion populations in AM; and hv is the energy of a laser output photon. Additional factor “2” in the denominator is introduced for accounting the Gaussian distribution of the beam in the laser cavity.

The pulse energy of the pump laser is approximately constant so that pump energy is roughly proportional to pump rate. It is seen in FIG. 3A that average power of the laser oscillation is a linear function of the pump rate; this behavior does not change substantially at transitions of the laser throughout the three modes of operation shown in FIGS. 2A(1) through 2C(2). FIG. 3B gives the repetition rate of giant pulses within the Area II, where a passive Q switch mode is realized. This dependence is quasi-linear at low pump powers, resembling the dependence of average power vs pump, slightly changing its behavior at approach to the border between the areas of stable passive Q switch mode and continuous operation of the laser. The reader should note that very similar features are observed experimentally.

FIGS. 4A, B, and C give the basic characteristics of giant pulses emitted by the laser in the passive Q switched mode described below: FIG. 4A shows the dependence of pulse duration vs pump power. FIGS. 4B and C show the dependences of pulse energy and peak power vs pump rate also have monotonously decreasing shape close to the threshold of CW operation; however, close to the passive Q switch mode threshold, some specific peculiarities are observed, which is, most probably, due to deviations of giant pulses oscillated at low pump powers from a symmetric Gaussian shape. A minimum of giant pulse duration and maxima of the pulses' energy and peak power are observed close to the middle point of the passive Q switch mode. This fact allows one to manipulate with the output parameters of the laser by simply changing the pump rate.

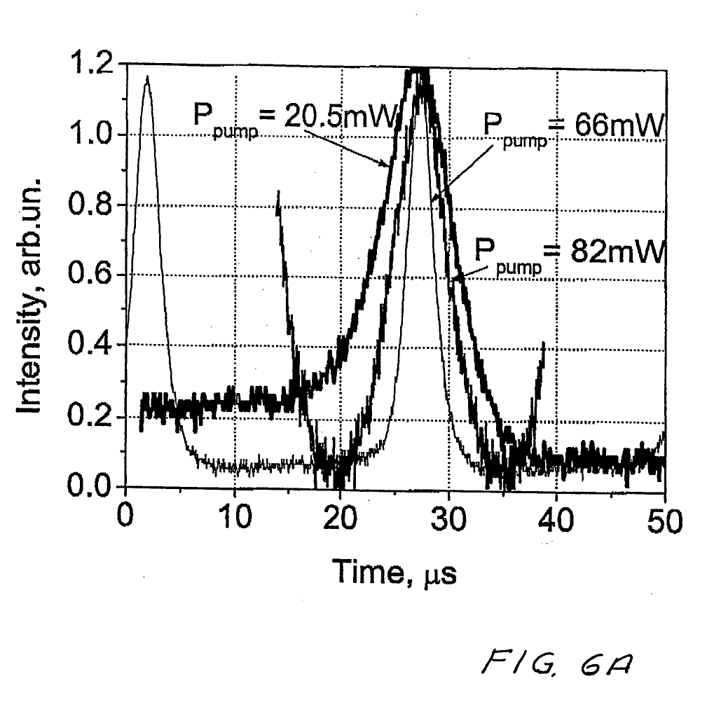

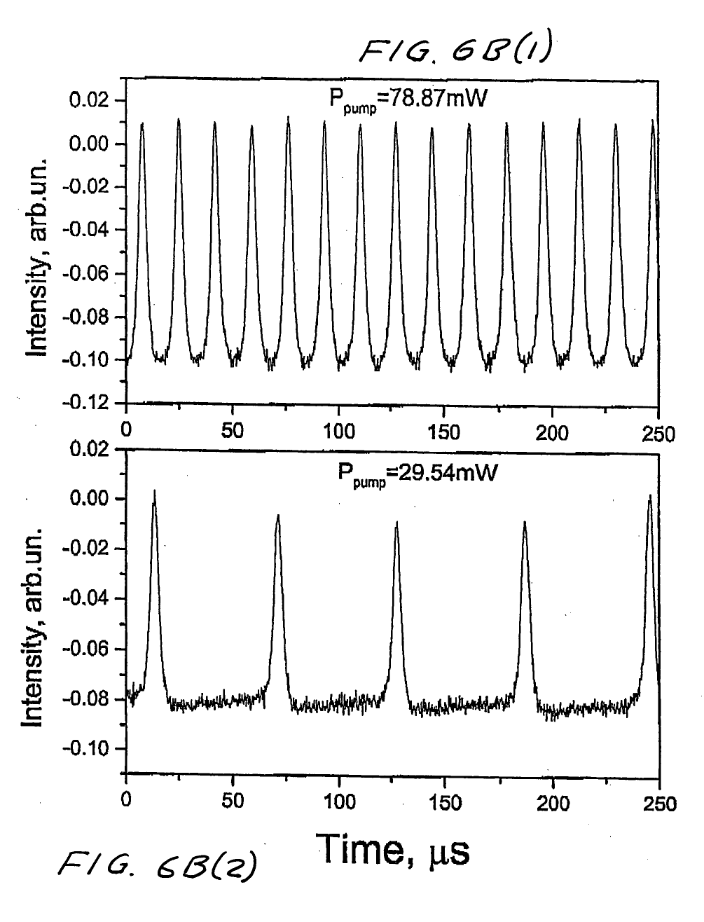

The laser threshold was measured to be 19.3 mW at wavelength 1559.5 nm, where the laser operates in the super-luminescence regime as shown in FIG. 2A(1). Just above the threshold of oscillation, with pump power increased up to 20.5 mW, the laser transited to the passive Q switched regime ass shown in FIGS. 2B(1) and (2), where stable giant pulses are generated. Giant pulses for three different values of pump power of a prototype unit are shown in FIOG. 6A. Close to the passive Q switched threshold (at 20.5 mW), the pulses in a train have asymmetrical shape (20.5 mW trace in FIG. 6A), but, as the pump power increases, the traces become close to Gaussian (66 and 82 mW traces in FIG. 6A). As shown in FIG. 6A, pulse width depends on pump power and the pulse width is measured within a few microseconds. Depending on the pump rate, pulse duration might be in the range 3-15 μs. Rather long pulse width of the giant pulses is the result of a considerably long length of the cavity. Thus, the pulse duration can be controlled to an extent by choosing the length of the cavity. Or the laser may be designed to provide maximum total pumping of the fiber to produce maximum pulse power. Pulse duration could also be shortened using a high-doped erbium fiber of short length (less than 2 m) as an active medium of the laser. In this case pulse duration could be in the range 0.5 μs-3 μs. FIGS. 6B(1) and (2) give snapshots of the pulses trains obtained at different powers (i.e., 78.87 mW and 29.54 mW) of the pump laser (these traces correspond to the pump powers slightly above the passive Q switched pulse threshold and slightly below the continuous wave threshold). The repetition rate of the pulses in a train increases with the pump repetition rate up to about 50 kHz.

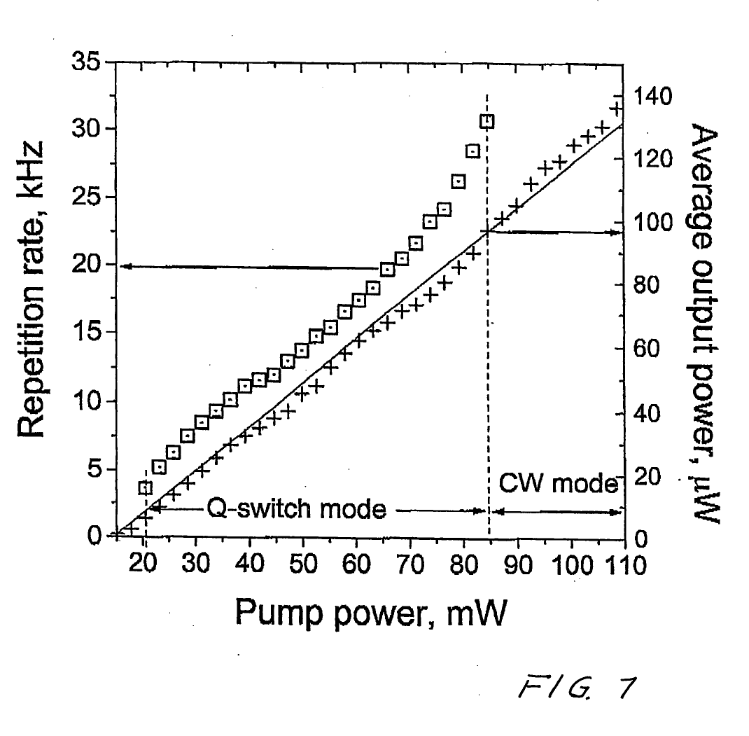

FIG. 7 provides the results of experimental data showing shows the dependencies of average output power of the laser (measured behind 88.5% FBG mirror 12 as shown in FIG. 1). The figure shows the repetition rate of giant pulses versus input power of the diode pump. Both curves are very close to linear, being practically parallel throughout the whole range of input powers. However, as observed in the laser modeling, some deviations from linear are observed for repetition rate dependence when pump power is close to the transition of the laser from passive Q switch mode to continuous wave operation (compare with FIGS. 3A and B). Applicants observe that in these circumstances the passive Q switch regime takes an unstable character with an appearance off timing jitter. FIGS. 8A and B show two different portraits of the laser dynamics measured. At further increase of pump power, the passive Q switch mode is replaced by continuous wave operation of the laser. The reader may compare with the results represented by FIGS. 2A, B and C). Continuous wave operation occurs when a period between the adjacent pulses approaches the pulse duration of the giant pulses, which, in turn, is determined by the cavity length. Applicants finally note that there is not much change in output power of the laser at transiting from the passive Q switch mode to the continuous wave one (see FIG. 7 and compare with FIG. 3A).

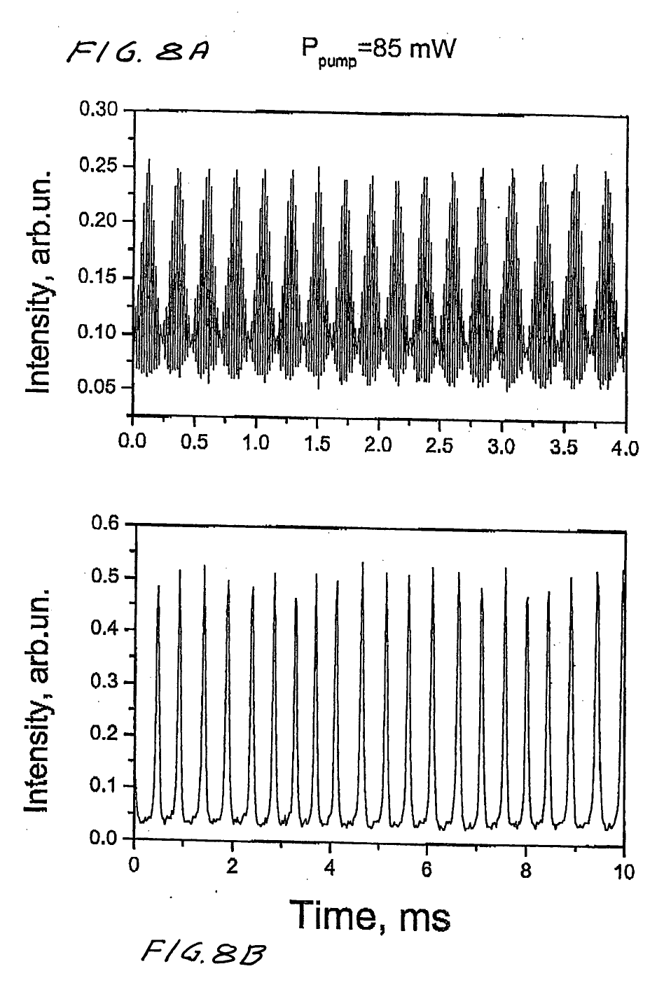

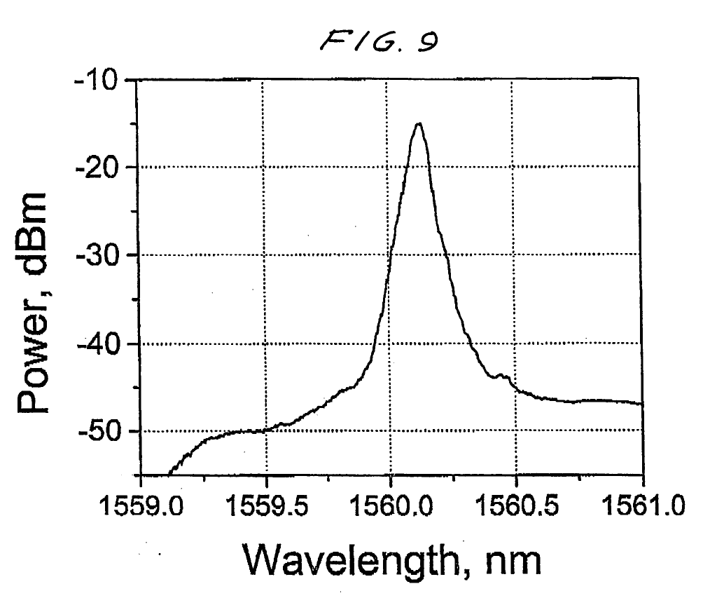

FIG. 9 gives the experimental characteristic spectrum of generation of the laser operating in the passive Q switch mode, a comparatively narrow line of generation is observed and it was possible to tune its maximum by a simple shifting or rotating the Co²⁺:ZnSe crystal in the U-bench. FIGS. 10A, B and C demonstrate, based on experimental data, the dependencies of the giant pulse duration (FIG. 10A), energy (FIG. 10B) and peak power (FIG. 10C) as functions of the pump power. The reader will note that all these parameters are in quite-good agreement with the ones predicted by the theory as shown in FIGS. 4A, B and C). Giant pulse characteristics such as maximums of the pulses' energy and peak power and minimum of the pulses' duration are centered at the middle point of the passive Q switch mode), it coincides with laser modeling both by time when it takes place and their magnitudes.

### Second Preferred Embodiment

In this embodiment Cr²⁺:ZnSe is substituted for Co²⁺:Zn. The parameters of the U-bench were chosen to produce power density of the intra-cavity radiation in the center of U-bench at about 60 kW/cm². The crystal Cr²⁺:ZnSe was placed near the center of U-bench to provide location of the beam waist of 1 μm close to the crystal center. The Cr²⁺:ZnSe crystal had antireflection coating at wavelength 1400-1800 nm. A sample of Cr²⁺:ZnSe crystal with initial transmittance Tᵢₙ=50-98% and thickness 0.3-1 mm, and the two fiber Bragg grating (FBG) mirrors with maximum of reflection of 100-95% and 70-98%, respectively. The bleaching power of a Cr²⁺:ZnSe is 60 kW/cm². Using this passive Q-switch modulator pulse duration as short as 10 ns to 500 ns might be obtained depending on the pump rate and the length of the fiber laser.

### Third Preferred Embodiment

A third preferred embodiment relates to an all-fiber laser master oscillator and a power amplifier to form MOPA configuration and produce more powerful laser pulses. As described above in the fiber laser with passive Q-switch, it is not possible to get more power of certain type of laser pulses simply by increasing the pump level of the laser. This is because the mode changes from that shown in FIGS. 2B(1) and (2) to 2C(1) and (2). However, by using a secondary fiber power amplifier, it is possible to substantially increase the power of the laser pulses formed in the laser MOPA system. The optical setup is shown at FIG. 11. The portion 3 of FIG. 11 enclosed by dots is the same as the fiber laser 3 shown in FIG. 1. The fiber power amplifier 30 is connected at the output of the fiber laser. The pump set up of the power amplifier is similar to that of the master oscillator using wavelength division multiplexer (WDM) 6 as shown in FIG. 1. By using the MOPA configuration it is possible increase laser power to at least 2 times as compared to a single oscillator.

### Optical Components

Samples of Co²⁺:ZnSe and Cr²⁺:ZnSe are available from International Laser Center, with office in Minsk, Belarus. Other optical fiber components are available from the following vendors: Newport Corporation with offices in Irvine, Calif., 3M Telecom, Austin, Tex., IPG Photonics, Sturbridge, Mass., New Focus, Santa Clara, Calif.

### Fourth Preffered Embodiment

In a fourth preferred embodiment an additional U-bench is introduced into the fiber laser. A nonlinear crystal for second harmonic generation is placed in the U-bench. This crystal can be a regular bulk nonlinear crystal such as KTP, BBO, KDP or an “engineered” periodically polled crystal such as PPLN (periodically polled Lithium Niobate) or PP KTP. In such configurations the U-bench works like a module for intra-cavity second harmonics generation. The laser light produced at the fundamental laser frequency (wavelength 1400-1800 nm) is frequency doubled in the nonlinear crystal to obtain light at the half of the fundamental laser wavelength (700-900 nm). In the case of U-bench with SHG crystal the FBG mirrors of the fiber laser should have high reflectance at the fundamental wavelength (R>95%) and the output mirror should be partially transparent at the half of the laser wavelength (50%<R<95%). The U-bench with SHG crystal is a way to widen spectral band of a fiber laser and its possible application.

### Medical Applications

Important applications of the present invention relate to the tissue modification that can include tissue coagulation, tissue destruction, tissue growth modulation, tissue heating and cooling.

FIG. 12 shows a cold fiber tip for subsurface eye tissues coagulation to treat below the sclera eye tissues in order to shrink tissues or change its optical properties. One of the applications is to modify sub-scleral eye lens tissue without opening its capsule to change a lens power. The cold surface of the optical fiber is included in a sapphire tip held in a copper rod and placed into a chilling chamber. During the procedure the cold saphire touches the eye surface and chills it allowing the laser pulses to pass through the sclera without damaging it and to modify layers of the tissue laying below the sclera.

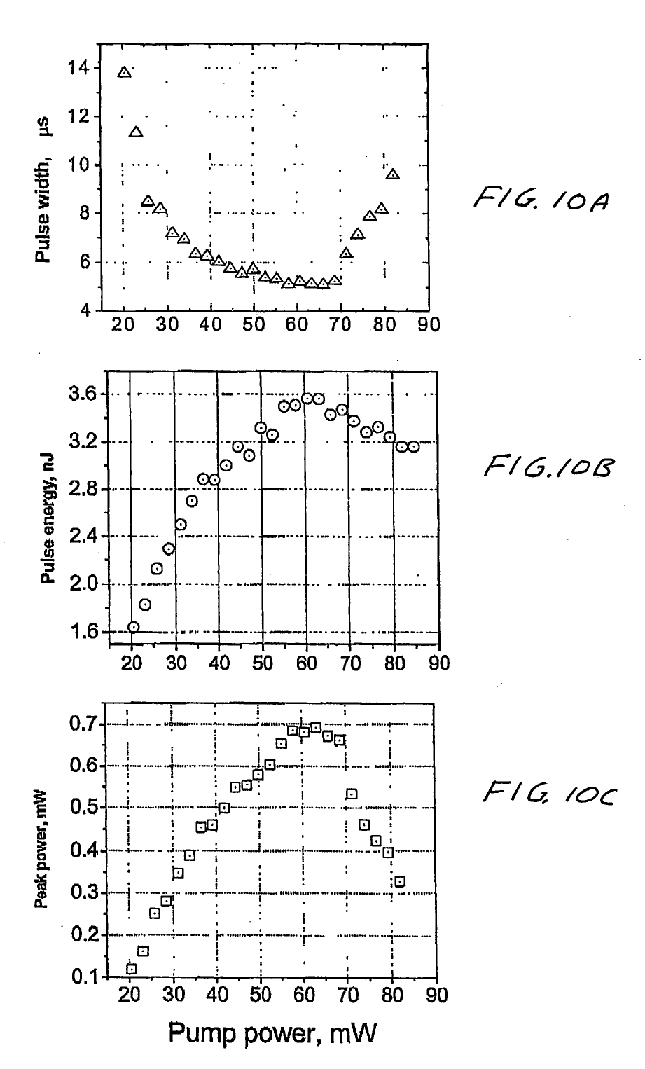

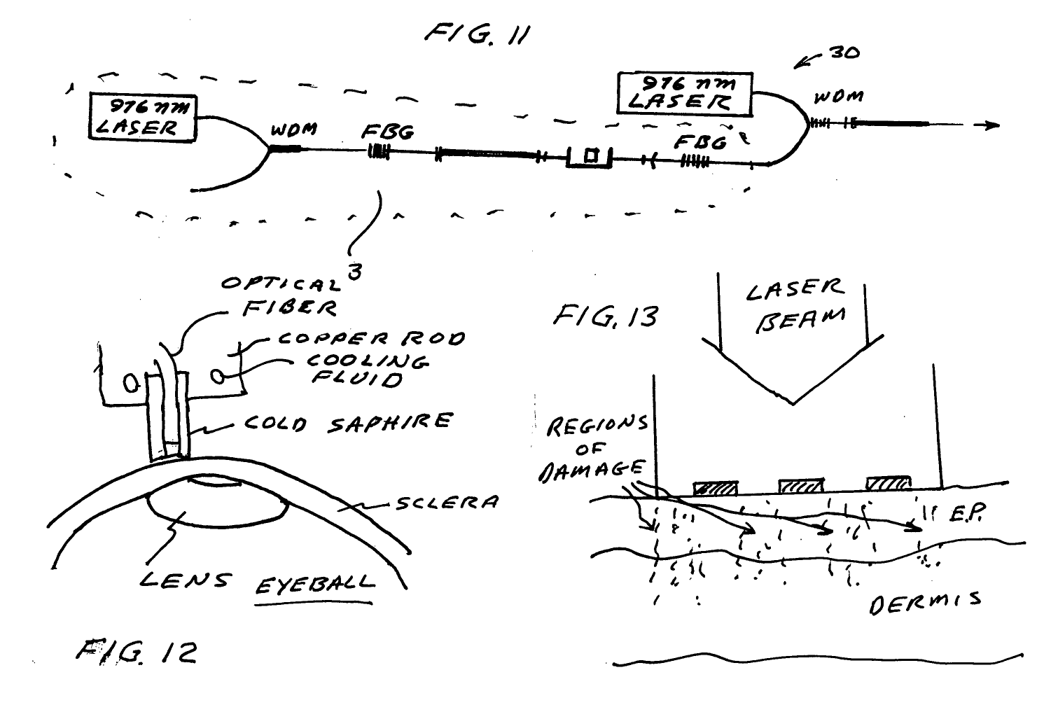

FIG. 13 demonstrates the similar a partially translucent and partially not translucent tip laser light. Masking the skin surface preserves healthy portions of the skin for a fast normal healing process. This process can be used for the immuno-modulation of the skin or immuno-modulation of the systemic response as well as a modulation of the growth factors and protein synthesis when necessary.

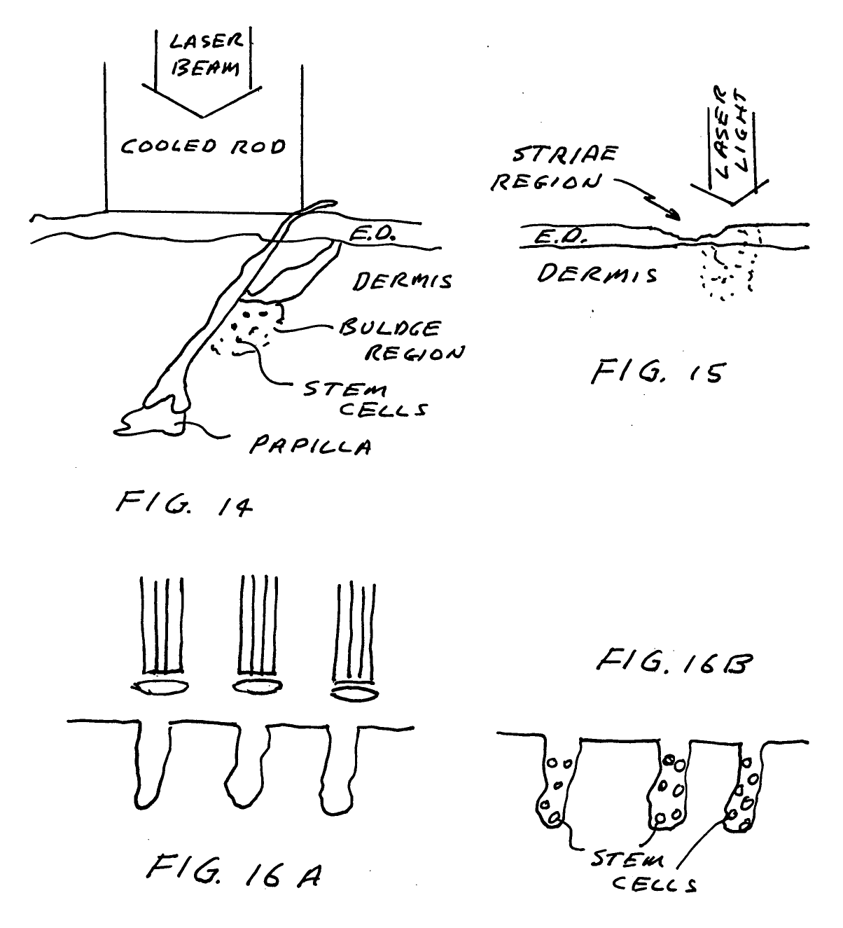

Partial cooling allows the laser light to heat skin tissue to deeper depths than is possible without surface cooling. This is very useful for the hair removal when is necessary to heat a deep hair papilla and stem cells containing bulge area below the erector pili muscle as shown on FIG. 14 without causing significant damage at the skin surface. The fiber laser to be used for hair removal should be a Yb+3 or Nd doped laser or other fiber lasers in one micron spectra range that allows its light to penetrate to the required depth to reach hair papilla and stems cells of bulge area.

The cooling of the skin surface is necessary when treating striaes or hypotrofic scars where the skin is thinner. FIG. 15 shows the treatment of the striae on the border with the healthy tissues. Laser light activates the minimal inflammation in the skin necessary to initiate a healing process with the collagen deposition further on into the striae zone from the healthy tissues. The treatment of hypertrofic scars does not required any cooling

FIG. 16 outlines the design of the needle type tip for the skin perforation for the hair transplantation. The first step is to create small holes on the skin scull to implant stem cells, hair cells, hair follicle or genetic material. When wound is healed, that usually takes two three weeks the skull skin is irradiated with cold masking tip in order to create a minimal inflammation in the low layers of the epidermis and the papillary dermis to stimulate growth factors production in order to stimulate a further healing and hair papilla and matrix faster cell proliferation. This procedure should be repeated within first six months after the transplantation until the hair will go through catagen-early anagen-anagen/telagen phase.

The use of a random delivery of a multiple beam for the myocardium re-vascularization, FIG. 17, can create smaller channels for the heart muscle re-vascularization and to develop a larger surface for the blood supply compare with the traditionally used one beam laser system.

Application for the use to drill hard dental or soft skin tissue is shown in FIG. 18. Multiple fibers are connected to the semispherical holder to create a fiber lens focused at a focal spot. A jet stream of the bucky balls (Fullerenes) or carbon particles suspension is directed into the focal spot positioned in the gap between a laser tip and tooth cavity. Q-switch pulse light interacts with the surface of the particle penetrating to the depth of around 10 nanometers, vaporizes it creating a tremendous force that accelerate particle to the surface of the tooth cavity. This force creates a pressure that capable to drill a cavity or hole on the surface of hard or soft tissue. Beyond the focal spot the laser beam expands so that its intensity is too low to cause any significant tissue damage.

The laser pulse energy and duration give rise respectively to the amount and rate of energy absorbed in light-absorbing chromophores respectively. For a given energy, the shorter the pulse duration, the higher the temperature rise in the light-absorbing medium. The absorbed energy is confined well inside the light absorbing chromophore at the end of a short duration pulse. Conversely, much of the heat may be dissipated into the surrounding medium if the pulse duration is very long. As a zero-order approximation, the energy dissipation distance in a given period of time can be written as:
x=\sqrt{ατ} (1)

where x in cm is the energy dissipation distance; τ in seconds is the duration of energy dissipation; α in cm²/sec is the thermal diffusivity, which is determined by the mathematic expression α=K/pc in which K is in J cm₋₁s⁻¹ C⁻¹ p is in g/cm³, and c is in Jg⁻¹ C⁻¹, represent the thermal conductivity, density, and thermal capacity, respectively. Table 1 lists the energy dissipation distances in graphite and skin during a period of 100 ns (Q-switched Yb+3 and Nd doped fiber laser pulse duration), 100 μs (typical duration of non-Q-switched or free running Nd:YAG laser), and 100 ms. Table 1 shows that for a 1 μm graphite particle, the absorbed energy is confined well inside the particle at the end of a 10 “short” ns pulse, but dissipates a significant distance from the particle during a “long” 100 μs pulse

TABLE 1
The energy dissipation distance X (μm)
in graphite & skin during period τ

| τ | | X_{graphite} | X_{SKIN} |
|---|---|---|---|
| 10 | ns | 0.16 | 0.03 |
| 100 | μs | 16.3 | 3.23 |
| 100 | ms | 515 | The thermal diffusivities |

(cm²s⁻¹) used in the calculation for graphite, mineral oil, and skin are 0.027, 7.94 × 10⁻⁴, and 0.001, respectively

Neglecting the energy loss due to dissipation, the instantaneous temperature rise in a light absorbing medium at the end of a 10 ns laser illumination can be expressed as
T=μ_{α}φ/ρc (2)
where μₐ in cm⁻¹ is the absorption coefficient; and φ in J/cm² is the laser fluence. Because of the high absorption coefficient of graphite, its instantaneous temperature rise is over 1000 C. even at a 0.1 J/cm² laser fluence. The vaporization temperature of graphite (about 3700 C.) is reached at about 0.3 J/cm². It takes about 7,686 J per gram to heat graphite from 0 C. to 3700 C. This method can be used as well to make holes or remove metal fillings or stents implanted into the tissue also in the process of making implants or just in industrial processes of the material treating processes.

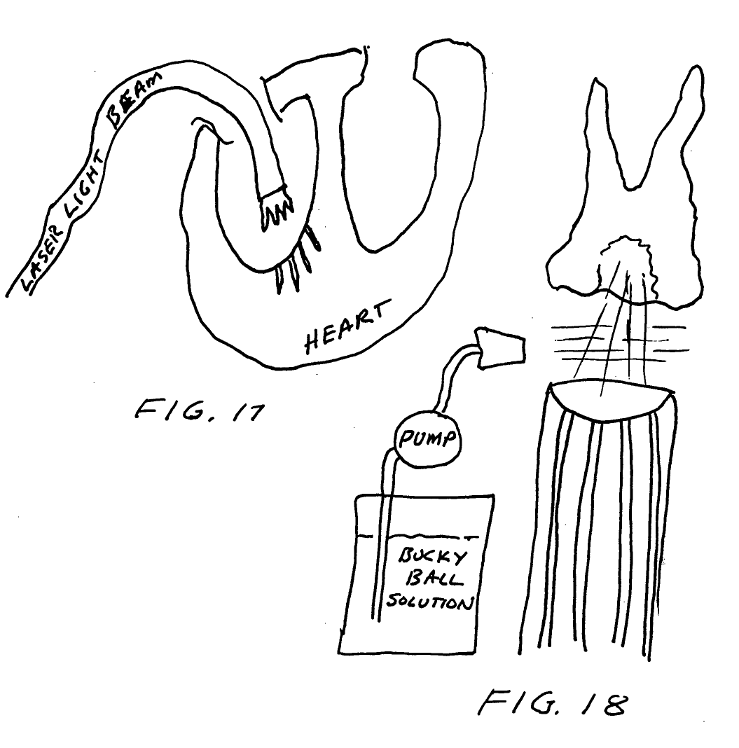

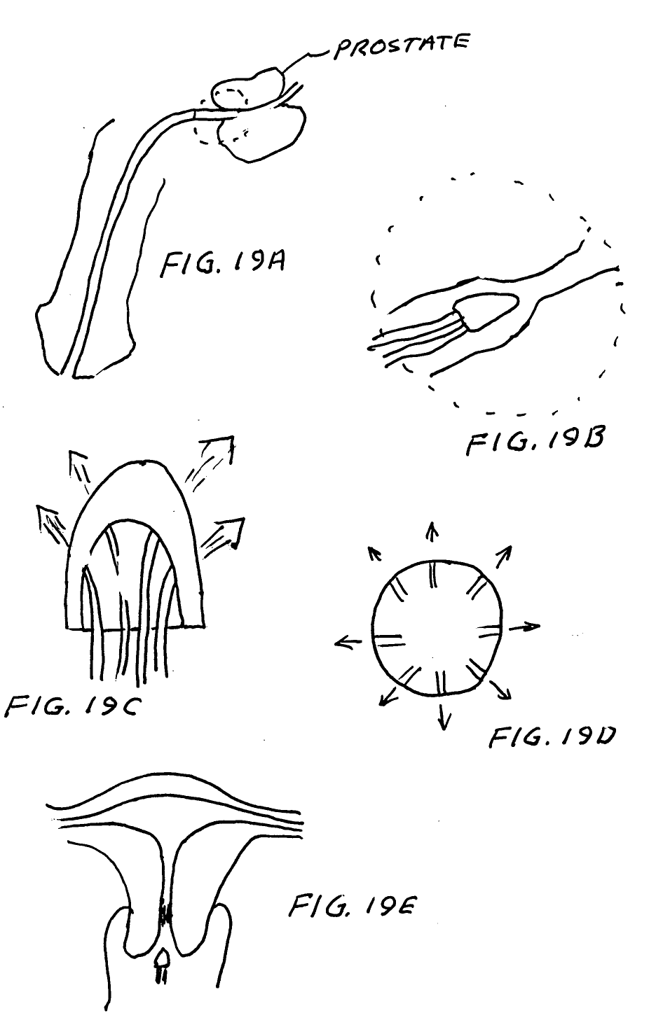

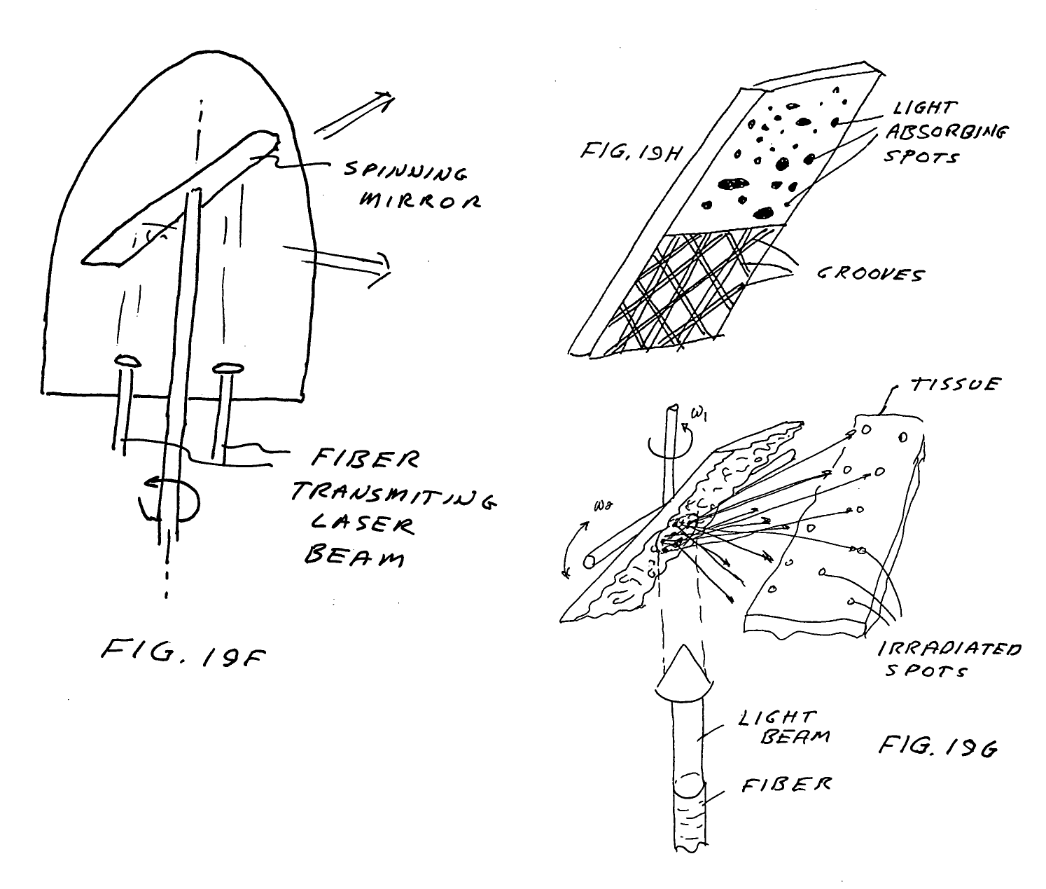

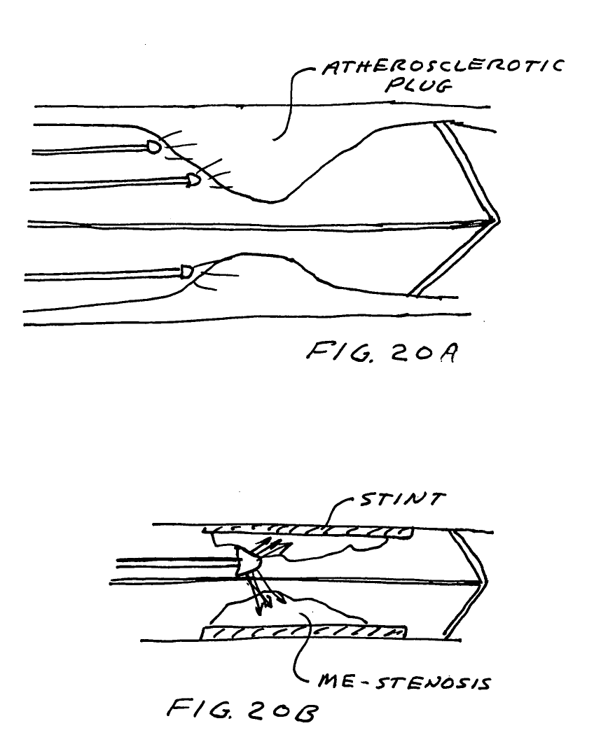

FIG. 19 shows the use of the multi-fiber cold sapphire bullet type tip, FIG. 19C, for the transuretral resection of Prostate, FIG. 19A, or its re-canalization, FIG. 19B, as well as for the uterine cervix re-canalization and shrinkage of the myomatous nodes, FIG. 19E. A bullet type cold sapphire translucent tip contains a scanning mirror rotating inside the cavity of the bullet and can oscillate in X and Y axis, FIG. 19F. A scanning window can have a flat reflecting back surface but non-uniform surface to break light into the randomly distributed beams of varying cross section size, FIG. 19G and FIG. 19H. A cryogen spray may be injected into the sapphire cavity cooling walls of the bullet. When radiation is passing through the sapphire wall it is also coming through the tissue surface chilled by the cold bullet heating back tissues to the normal temperature but increasing the temperature in the tissues below cold layers. This heating of the underlying tissues coagulated tissue proteins transforming and shrinking tissues allowing an opening of closed canals or shrink unwanted enlarged tissues like myomatous nodes or prostate. FIG. 19G shows the scanning mirror for the random spots non-uniform tissue irradiation. The reflecting surface of the scanning mirror is made not smooth and polished but rough and uneven. It allows to break a beam into the small portions, fluence and direction wise, and create separated irradiated islands on the tissue leaving unaffected spots as a source for healthy response to the neighboring tissues damaged or transformed. The mirror contains not reflecting but light absorbing spots that makes beam non-uniform in its cross section, FIG. 19H. Computer Simulations of surface and subsurface temperature rise and its estimation can be made by calculating laser light fluence in tissue and estimating energy deposition per unit volume of tissue. Effect of contact tissue surface cooling was accounted based on the solution of heat transfer equations.

In order to choose proper light fluence in blood vessel the following optical properties of tissue have been used:

| | Absorption | Scattering | Asymmetry | Refr. | |
|---|---|---|---|---|---|
| | coef | coef | Factor | Index | |
| | (1/cm) | (1/cm) | (g) | n | Thickness |
| Intima | 5 | 300 | 0.8 | 1.4 | 100 micron |
| Media & | 8 | 100 | 0.85 | 1.4 | Semi- |
| Adventitia | | | | | infinite |
| Blood | 10 | 300 | 0.98 | 1.4 | N/A |

At a wavelength of 1.54 micron, absorption in tissues is determined primarily by their water content. Water content of whole blood is more then 90%, whereas in intima and tunica and adventitia it is about twice less. For this reason absorption of IR radiation and temperature rise in blood is about two times higher than in surrounding arterial wall tissue. Once fluence in the vessel wall is calculated and a depth of absorption is estimated, the temperature rise ΔT due to light absorption can be roughly estimated as follows:
ΔT=Q/mc
where skin density is about 1.15 g/cm³ and specific heat of skin about 3.8 J/Cgm.

Effect of endothelial intima surface cooling on temperature distribution in blood vessel tunica and adventitia have been estimated by solving heat transfer equation in semi infinite arterial wall tissue with boundary conditions corresponding to constant 5° C. temperature of the surface (or other constant temperature of the sapphire bullet tip). Temperature distribution in ° C. in arterial wall then can be calculated by formula:
T(z,t)=37*erf(z/2 αt),
where erf refers to the Gausian error function, and z is the depth into the tissue, t is time lapse in seconds from the start of the contact tissue cooling and α=10⁻⁴ (cm²/sec) is thermal diffusivity of arterial wall. Skin temperature was found by superposition of laser heating and surface cooling effects.

Various elaborate computer programs are available for more precise estimate of temperature distribution within the blood vessel as a function of time. Applicants have made analysis using a Monte-Carlo computer code specifically modified for arterial blood vessel thermodynamic analysis and some of the results are shown in FIGS. 19J and 19K.

FIG. 20 shows the use of the multibullet fiber tips for the atheroectomy or re-stenosis and thrombosis re-canalization. Multibullet fiber tips are incerted into the endovascular catheter and administrated into the closed artery to the atherosclerotic plug. With the help of the balloon angioplasty a vessel blocking device (usually umbrella type device) is moved though the closure and opened behind it to stop a blood flow. Atherosclerotic plug and then freezed with the sprayed cryogen coolant. A fast heating with Q-switch pulses of the laser radiation brake a part a portion of the plug at the depth around 500 micron. Then a procedure is repeated until the desired results are achieved. The similar procedure can be applied for the re-stenosis treatment.

The reader should understand that the above specific embodiments of the present invention are merely examples and that many changes and modifications could be made without departing from the important concepts of the present invention. For example, many materials that are absorbed of light at specific wavelengths but saturate at particular laser thresholds may be substituted for the two crystals described in detail. In fact the above described unit could be used as a sensor. For example, if a substance such as a lightly absorbed gas or liquid is substituted for the crystal, then as light passes through that U-bench its attenuation could be measured. Because the U-bench is a part of laser resonator light traveling in the U-bench many times increasing over-all sensitivity of the sensor. This approach is known as intracavity spectrometry. Therefore, the reader should determine to scope of the present invention by the appended claims and their legal equivalents.

We claim:

1. An passive Q-switched optical fiber laser comprising:
A. a pump laser for producing laser light at a first wavelength,
B. a first optical fiber doped at least in part with an element for absorbing said first wavelength to produce laser light at a second wavelength, said first optical fiber having a first polished fiber end defining a first exit/entrance aperture and a second optical fiber with a second polished end defining a second exit/entrance aperture,
C. a optical insertion means for inserting laser light from said pump laser into said first optical fiber,
D. two lenses,
E. a saturable absorber,
F. a frame structure for holding in position said first and second polished fiber ends, said saturable absorber and said two lenses, in positions such that laser light exiting said first fiber end is focused inside said saturable absorber and within said second exit/entrance aperture of said second fiber end and such that laser light exiting said second fiber end is focused inside said saturable absorber and within said first exit/entrance aperture of said first fiber end,
G. a first mirror means and a second mirror means positioned on opposite sides or said positioning element to produce a resonance cavity.

2. The laser in claim 1 wherein said frame structure is a U-bench.

3. The laser as in claim 1 wherein said first optical fiber is doped with erbium.

4. The laser as in claim 1 wherein said optical insertion means is a wave divider multiplexer.

5. The laser as in claim 1 wherein said two lenses are ball lenses.

6. The laser as in claim 1 wherein said saturable absorber is a crystal.

7. The laser as in claim 6 wherein said crystal is a Co²⁺:ZnSe crystal.

8. The laser as in claim 6 wherein said crystal is a Cr²⁺:ZnSe crystal.

9. The laser as in claim 1 wherein said first mirror means and said second mirror means are both fiber Bragg grating mirrors.

10. A method of producing modifications in living tissue utilizing a laser beam in an optical fiber wherein said laser beam is generated in a passive Q-switched optical fiber laser comprising:
A. a pump laser for producing laser light at a first wavelength,
B. a first optical fiber doped at least in part with an element for absorbing said first wavelength to produce laser light at a second wavelength, said first optical fiber having a first polished fiber end defining a first exit/entrance aperture and a second optical fiber with a second polished end defining a second exit/entrance aperture,
C. a optical insertion means for inserting laser light from said pump laser into said first optical fiber,
D. two lenses,
E. a saturable absorber,
F. a positioning element for holding in position said first and second polished fiber ends, said saturable absorber and said two lenses, in positions such that laser light exiting said first fiber end is focused inside said saturable absorber and within said second exit/entrance aperture of said second fiber end and such that laser light exiting said second fiber end is focused inside said saturable absorber and within said first exit/entrance aperture of said first fiber end,
G. a first mirror means and a second mirror means positioned on opposite sides or said positioning element to produce a resonance cavity.

11. The method of claim 10 wherein said tissue being modified is sub-scleral eye tissue.

12. The method of claim 11 wherein said laser beam is delivered to said sub-scleral eye tissue with an optical fiber held within a cooled sapphire tip.

13. The method of claim 10 wherein tissue adjacent to tissue being modified is masked to prevent damage so that it remains healthy so as to speed a fast healing for modified tissue.

14. The method as in claim 10 wherein said tissue being modified lies below tissue protected from modification by cooling.

15. The method as in claim 10 wherein tissue being modified creates a site for hair transplation.

16. The method as in claim 10 wherein said tissue being modified is heart tissue and the laser beam is applied through an optical threaded through an artery to the inside of the heart.

17. The method as in claim 10 wherein the tissue being modified is tooth tissue and carbon particles are exploded to produce the modification.

18. The method as in claim 17 wherein the carbon particles comprised buckey balls.

19. The method as in claim 17 wherein the tissue being modified is prostate tissue.
